(19) United States
(12) Patent Application Publication
(10) Pub. No.: US 2020/0189242 A1
(43) Pub. Date: Jun. 18, 2020

(54) SOUND INSULATING MAT, METHOD OF MANUFACTURING THE SAME, NOISE CONTROL SYSTEM COMPRISING THE SAME AND ITS USE

(71) Applicant: FPInnovations, Pointe-Claire (CA)

(72) Inventors: Xiaolin CAI, Kirkland (CA); Fabrice ROUSSIERE, Quebec (CA); Lin HU, Quebec (CA); Xixian (James) DENG, Quebec (CA); Anes OMERANOVIC, Quebec (CA); Ayse ALEMDAR-THOMSON, Vancouver (CA); Gilles BRUNETTE, Quebec (CA)

(73) Assignee: FPInnovations, Pointe-Claire, QC (CA)

(21) Appl. No.: 16/466,875

(22) PCT Filed: Dec. 13, 2017
(86) PCT No.: PCT/CA2017/051509

§ 371 Date: Jun. 5, 2019

Related U.S. Application Data
(60) Provisional application No. 62/433,961, filed on Dec. 14, 2016.

(51) Int. Cl. B32B 21/10; B32B 3/26; B32B 21/02; B32B 13/14; B32B 5/02; B32B 7/12; B32B 13/10; G10K 11/168; E04B 1/84; E04F 15/20

(52) U.S. Cl. CPC B32B 21/10; B32B 2419/00; B32B 21/02; B32B 13/14; B32B 5/022; B32B 7/12; B32B 13/10; G10K 11/168; E04B 1/8409; E04F 15/203; B32B 2250/05; B32B 2255/02; B32B 2260/021; B32B 2262/067; B32B 2262/14; B32B 2307/102; B32B 2307/546; B32B 2307/732; B32B 3/263

(57) ABSTRACT

There is provided a sound insulating mat for sound insulation comprising at least a layer of combined natural fibers-binder web. The web comprises natural fibers in the range of 60 to 9 wt. % of the web; and a synthetic binder in the range of 5 to 40 wt. % of the web. The web comprises a thickness and at least an upper surface and a lower surface opposite each other, and has a bulk density of 40 to 150 kg/m³. There is also provided a method for manufacturing the sound insulating mat and a noise control system comprising the sound insulating mat.

### TECHNICAL FIELD

The present description relates generally to sound insulating mats for buildings, transportations and the like, and more specifically to sound insulating mat comprising an uneven profile in thickness cross-section and the method for manufacturing the same. The present description also relates to noise control systems comprising the insulating mat and their use.

### BACKGROUND

One of the most common complaints of building occupants stems from the impact sound propagated through the floor-ceiling assembly, especially the low-frequency sound. Low-frequency sound has a long wavelength and a low material absorption rate, which gives it the capacity to travel great distances. Low-frequency sound is non-directional in how it radiates its sound waves. To a human, this means the sound is heard, but the source cannot be located. Because low-frequency sounds seem to bypass the ear and are more “felt” than heard, this can lead to physical and physiological effects that are difficult to quantify, but easy to justify as responsible for feelings of anxiety and stress (ROXUL 2016). For example, when footsteps fall upon an improperly designed noise control system, typically present in lightweight floor-ceiling assemblies, a low-frequency impact noise is generated that transmits through the floor-ceiling assembly from the upper unit to the unit below.

From a building perspective, the lightweight wooden construction has greatly increased during the past years, and with this development there has also been an increase in the number of complaints from the occupants about noise disturbance from adjacent neighbors. Here again, the problem can often be related to low-frequency impact sound insulation (Sousa and Gibbs 2011). In fact, low-frequency sounds are much more difficult to control in this type of building and can be a major cause of complaints in multi-family buildings (Burrows and Craig 2005). With a typical wood floor supported by wood joists, more low-frequency sound is transmitted than in the case of a concrete floor. Most of the sound energy that reaches the room below, and that determines the impact insulation rating, is in the low-frequency band range below 250 Hz. The addition of a resilient covering such as a rug or linoleum can reduce high frequency sound transmission but this reduction does not necessarily increase the impact sound insulation rating if the low frequency levels are not also reduced significantly (Warnock 2000).

Most of research and development activities in sound insulation emphasize either the structural design or the development of sound insulating materials. Rarely are both structural assembly design and material development combined. For example, extensive research on floating floor structures in construction and the use of different market available acoustic resilient materials to improve impact sound insulation have been developed (Schiavi et al. 2007; Kim et al. 2009; Yoo et al. 2010; Stewart and Craik 2000; Hui and Ng 2007; Sousa and Gibbs 2011; Jeon et al. 2004; Pritz 1994).

There are many acoustic resilient materials on the market. In general, current acoustic resilient materials on the market can be classified into 5 types including cork, felt, wood fiberboard, rubber materials, and foams. The limitations of each type of acoustic resilient materials are described in the following paragraphs.

Cork is harvested only in the Mediterranean region. The major drawbacks of cork include the expensive price of the materials, the cost of binders to make it, and the transportation cost from Europe to the rest of the world. So despite its bio-based origin, the transportation to North America impaired its carbon footprint.

Felt is a type of resilient sheet or matted fibers from virgin or recycled textile fibers that are bonded together by needle punch and/or chemical processes. The major application of felt is for furniture fillings. Felt entrance into the sound insulation is mainly due to the ease of installation because of their roll form and because the reuse of textile fibers classifies them as green or environmentally favorable.

Wood fiberboards are used as a low-cost impact sound material. Problems associated with wood fiberboard include the poor to moderate acoustical performance in floor systems, panel handling and installation issues, poor water resistance and potential urea-formaldehyde binder emissions that negatively affect the indoor air quality. In the scientific literature, Faustino et al. (Faustino et al. 2012) developed a corn cob particle board to reduce impact sound transmission in buildings. This material is produced in a similar process as a wood particle board. In the patent literature, DE Patent 10028442 (Kalwa 2001) disclosed a plate for reducing noise for building floor coverings. The object of the invention is a wood fiber board that can be used under laminate floor finish as sound insulation. The fiber board product was claimed to dampen the sound and thus significantly reduce impact sound. The wood fiber board according to the invention is preferably provided with a perforation and has a thickness of 25 mm to 6 mm. It is connected to a pattern of holes with a diameter of 2 mm to 6 mm and spacing of about 15 cm to 4 cm.

Rubber materials are currently used as impact sound material in different forms. The main drawback of rubber resilient acoustic materials includes high cost and the loss of sound insulation properties once aged. Rubber materials are petroleum-based products that may release toxic fumes and volatile organic compounds. Similarly, the main drawbacks of synthetic foam sound insulation products are that they are petroleum-based products that release toxic fumes in the event of a fire.

In summary, the existing acoustic resilient products on the market have some inferior characteristics such as poor sound insulation properties (wood fiberboard); high cost products (cork, rubber and synthetic polymer foam) with additional high transportation costs, deterioration of insulation properties with age and high carbon footprint. There remains a need to develop high performance acoustic resilient materials with a low environmental impact and with proper sound insulation structural design, which will provide superior performance of sound insulation, especially superior impact sound insulation performance for building construction.

Different fibers, filament materials and approaches are used worldwide to produce fibrous insulating materials. U.S. Pat. No. 5,554,238 (English 1996) described a method to produce a resilient batt for thermal insulation comprising natural and thermoplastic fibers. In this method, the thermoplastic fiber used is a monolithic type and the material surfaces are flame-treated to form a skin and trap the cellulosic fibers.

U.S. Pat. No. 5,516,580 A (Frenette et al. 1996) disclosed a process to manufacture insulating material comprised of loose fill short cellulose fibers and bonding synthetic fibers. The latter fibers are bi-component fibers that are composed of an outer sheath with a low melting point and an inner core with a high melting point. When treated thermally, the bicomponent fibers melt and act as a binder of the web. The product of this patent can form a body having the shape of a batt of insulation and the batt may be provided with a facing sheet of suitable vapor permeability. The final application of this product is not specified for thermal or sound insulation.

U.S. Pat. No. 7,918,313 (Gross et al. 2011b) disclosed a method to produce acoustic insulating material comprising cellulosic fibers and bi-component fibers made with air laid process, which may contain 40-95% of cellulosic fibers. The formulation compromises up to 5%-60% core binder of bi-component fiber binder, a latex binder, a thermoplastic powder or a mixture thereof, and the core has a basis weight from 200 gsm-3000 gsm and the density is ranged from 15 kg/m³-100 kg/m³. A sound transmission reduction of 5 decibels or greater via the Laboratory Sound Transmission Test was claimed. The material can be molded and used for automobile acoustic insulation applications. The same inventor (U.S. Pat. No. 7,878,301, Gross et al. 2011a) described another insulating material comprising cellulosic fibers, synthetic fibers and other binder with fire retardant. The disclosed method emphasized the fire barrier properties of the materials.

U.S. Pat. No. 6,514,889 B1 (Théorêt et al. 2003) disclosed a non-woven synthetic sheet material using for sound and/or thermal insulation. The 100% synthetic fiber sheet is needle-punched from one of the opposed flat surfaces to make the synthetic fiber interwoven. A polymeric film was added to the surface and it can be used in strip form in the wood framing structures.

U.S. Pat. No. 8,544,218 (Dellinger et al. 2013) described a sound insulation product for building construction, which includes a base entangled net material and an acoustical material which was made of 100% polymeric synthetic fibers.

US Patent Application 2011/0186381 (Ogawa et al. 2011) disclosed a sound-absorbing material consisting of a fiber sheet made of fibers containing at least 50% by mass of a porous fiber. The fiber sheet and sound-absorbing material had many minute pores with an airflow resistance ranging between 0.05 and 3.0 kPa s/m. The pulp fibers have a beating or refining degree in the range of between 350 and 650 ml on the basis of Canadian Standard Freeness (CFS) provided in HS P 8121-1995-4 Canadian Standard Freeness.

Patent DE 202 006 015 580 (Polywert GmbH 2015) described a method to produce sound insulation layer to be placed under load distribution layers. The insulation layer consisted of mechanically and/or thermally bonded plastic fibers, preferably polyester, with a surface weight of 200-1000 g/m² and a thickness of 1-20 mm.

U.S. Pat. No. 7,674,522 (Pohlmann 2010) developed a wood fiber insulating material board and/or mat in which the wood fibers and the binding fibers are aligned spatially. The fabric made of wood fibers and binder fibers can alternatively be sprinkled with plastic resin granules. One or both sides of a woven fabric or foil are applied to the wood fiber insulating materials. The resulting product was calibrated to the desired final thickness in a heating and annealing furnace. The boards or mats have thicknesses of 4 to 350 mm and bulk densities ranging from 20 to 300 kg/m³.

U.S. Pat. No. 7,998,442 (Pohlmann 2011) also disclosed a sound insulation board with a continuous density gradient which comprises a mixture of unglued wood fibers, a binder and/or supporting synthetic fibers and a mixed plastic fiber on a lower side of the board. The sound-insulating board, comprising 50 to 60% of a mixture of unglued wood fibers, 42 to 30% of a mixed plastic fiber of a type arising during a recovery of plastic parts from a dual system, and 8 to 10% of binders formed of thermoplastic synthetic resins and/or supporting fibers.

US Patent Application 2006/0143869 (Pohlmann 2006) disclosed another process to produce wood fiber insulating material board or mat covered by a nonwoven fabric or film on one or both sides, where the wood fibers are mixed with binder fibers to get a fleece with or without synthetic resin granules scattered on it. The product was consolidated with heat to soften the binder fiber and synthetic resin granules. The thickness of wood fiber insulating boards and mats produced by the process is from 3 to 350 mm. A good transverse tensile strength and an improved compressive rigidity were claimed. Of note, the rigid or semi-rigid nature of Pohlmann's boards or mats have limited the application and increased the installation complexity.

In summary, the prior art discloses no natural fiber insulating materials or sound insulating mats having an uneven cross-section profile in relation to depth or thickness. Furthermore no noise control system comprising an insulating material has been disclosed, in order to ensure proper acoustical performance. Indeed, it is known that insulating material, even those described in this invention, will not provide optimal sound insulation if improperly assembled.

Furthermore the insulating materials of the prior art have a common drawback in that rigid or semi-rigid panels, boards or mats are described. These materials are hence more difficult to transport and install leading to poor acceptance in markets.

### SUMMARY

According to an aspect, there is provided a sound insulating mat for sound insulation comprising at least a layer of combined natural fibers-binder web, the web comprising: natural fibers in the range of 60 to 95 wt. % of the web; and a synthetic binder in the range of 5 to 40 wt. % of the web. The web comprises a thickness and at least an upper surface and a lower surface opposite each other. The web has a bulk density of 40 to 150 kg/m³.

In some embodiments, at least one of the upper surface and the lower surface has an uneven cross-section profile through the thickness of the web. The uneven cross-section profile can comprise deformations in relation to thickness of the sound insulating mat. The deformations can comprises lumps, indentations, holes, contours, two-dimensional grooves, three-dimensional sinusoidal surfaces, parabolas, spot bonding, or a combination thereof. The deformations can be arranged in a repeating pattern or a random pattern. The amplitude of the deformations can be of at least 15% of the mat thickness

In some embodiments, the sound insulating mat is a footfall mat.

In some embodiments, the natural fibers comprises virgin fibers from wood chips, sawdust, plants, agricultural residues, non-virgin recycled fibers from recycled paper, recycled corrugated cardboard, recycled cotton fibers, textile fibers or a combination thereof. The virgin fibers of plants comprise flax fibers, hemp fibers, jute fibers, Kenaf fiber, bamboo fiber or a combination thereof. The ratio of virgin fibers to recycled fibers can be in a range from 0/100 to 100/0. The natural fibers can comprise mechanical pulp fibers, thermomechanical pulp fibers, chemi-thermomechanical pulp fibers, chemical pulp fibers, ground wood fibers, medium density fiberboard fibers, market pulp fibers or a combination thereof. The natural fibers can be pre-treated for humidity, fungal growth and/or fire resistance.

In some embodiments, the binder comprises synthetic fibers and/or latex. The synthetic fibers can comprise polypropylene, polyethylene, bicomponent fibers, polylactic acid, polylactide or a combination thereof.

In some embodiments, the ratio of the natural fibers on the binder is in the ranged of 95/5 to 60/40.

In some embodiments, the sound insulating mat further comprises a post-treatment barrier for water, vapor, and/or moisture protection.

In some embodiments, the mat is flexible and has a preferred dynamic stiffness in the range of 3 to 100 MN/m³. The dynamic stiffness can be in the range of 4 to 20 MN/m³.

In some embodiments, the sound insulating mat further comprises at least an additional layer, the additional layer being a combined natural fibers-binder web as defined herein, a flat insulating layer, or an even cross-section profile.

According to another aspect, there is provided a method for producing a sound insulating mats with even surface or uneven cross-section profiles, with or without perforation, and/or combined with a designed noise control system assembly that provide three-lines of defense for noise control of building construction.

According to yet another aspect there is provided a method for manufacturing an insulating mat comprising at least a layer of combined natural fibers-binder web. The method comprises the steps of mixing previously opened natural fibers and a synthetic binder to form a natural fibers-binder mixture, the natural fibers representing 60-95 wt. % of the web and the synthetic binder representing 5-40 wt. % of the web; forming the web from the natural fibers-binder mixture, the web having a thickness and at least an upper surface and a lower surface opposite each other; and processing the web so that at least one of the upper surface and the lower surface has an uneven cross-section profile through the thickness of the web, the web having a bulk density of 40 to 150 kg/m³.

In some embodiments, the method further comprises, prior to the mixing step, pre-treating the natural fibers for humidity, fire and/or fungal growth resistance, and/or mechanically treating the natural fibers.

In some embodiments, the method further comprises post-treating the insulating mat to provide water, vapor and/or moisture protection.

In some embodiments, the method further comprises bonding at least an additional layer to the layer of combined natural fibers-binder web, the additional layer being one of a layer of combined natural fibers-binder web as defined herein, a flat insulating layer, or an even cross-section profile.

In some embodiments, the uneven profile is produced using cold calendaring, hot embossing, thermal point bonding, one-side embossing, two-side embossing, tip-to-tip embossing, hole-making embossing, hole-making stamping, a subtractive process or a combination thereof. The subtractive process can be hole punching, hole embossing, hole piercing, die cutting, perforating, slotting or a combination thereof.

In some embodiments, webbing the natural fibers-binder mixture comprises using an air-laid process or a carding process. In some further embodiments, the web can be consolidated using thermal bonding in hot air-through dryer after the air-laid process or cross-lapped and needle punched after the carding process.

According to a further aspect, there is provided a noise control system for floor-ceiling comprising at least one insulating mat as described herein, and at least two of a floor finish surface, a topping or a structural floor.

In some embodiments, the noise control system comprises the insulating mat stacked between a topping and a structural floor. The noise control system can also comprise the insulating mat stacked between a floor finish surface and a structural floor. The noise control system can further comprise the insulating mat stacked between a floor finish surface and a topping.

In some embodiments, the noise control system comprises a first and a second insulating mats, the first insulating mat being stacked between a floor finish surface, and topping, and the second insulating mat being stacked between the topping and a structural floor.

In some embodiments, the floor finish and the structural floor are made of wood or concrete.

### DESCRIPTION OF THE DRAWINGS

Reference is now made to the accompanying figures in which:

“NFSIM” stands for Natural Fiber Sound Insulating Mat which refers to the sound insulating mat according to the present invention. The reference numbers from NFSIM 1 to NFSIM 10 each represent different formulations.

FIG. 1 is a set of schematic diagrams of different cross-sectional shapes: (A) 3D sinusoidal surface (B) sinusoidal surface or grooves (C) diagram of perforated mat;

FIG. 2 is schematic drawings of (A) a control reference uninsulated system (Ref.-Assembly I), and (B) a noise control system-Assembly I comprising a sound insulating mat according to an aspect of the present invention;

FIG. 3 is schematic drawings of (A) a control reference uninsulated system (Ref.-Assembly II), and (B) noise control system-Assembly II comprising a sound insulating mat according to another aspect of the present invention;

FIG. 4 is schematic drawings of (A) a control reference uninsulated system (Ref.-Assembly III), (B) and (C) noise control systems-Assembly III comprising a commercial product and a sound insulating mat according to a further aspect of the present invention;

FIG. 5 is a graph comparing the Field Impact Insulation Class (FIIC) of the reference system (Ref.-Assembly I) to noise control systems-I (Assembly I-NFSIM1 and Assembly I-NFSIM2) according to an aspect of the present invention;

FIG. 6 is a graph comparing the FIIC of the reference system (Ref.-Assembly II) to noise control systems-II (Assembly II-NFSIM3 and Assembly II-NFSIM4) according to an aspect of the present invention for (A) structural wood floor, and (B) structural concrete floor;

FIG. 7 is a graph comparing the FIIC of the reference system (Ref.-Assembly III) to noise control systems-III (Assembly III-commercial product and Assembly III-NFSIM5) according to an aspect of the present invention;

FIG. 8 is a graph comparing the FIIC of noise control systems having flat invented sound insulating matts and noise control systems having the invented sound insulating matts with uneven cross-section profile according to an aspect of the present invention, for (A) embossed insulating mat vs. flat mat (NFSIM6, NFSIM7, and NFSIM8), or (b) perforated insulating mat vs. flat mat (NFSIM5 and NFSIM10);

FIG. 9 is a graph comparing the Absorption Normalized Impact Sound Pressure Level (dB) of conventional wood fiberboard, rubber or felt-based sound insulating materials to invented sound insulating materials (NFSIM1, NFSIM5, NFSIM8) in a noise control system according to an aspect of the present invention;

FIG. 10 is a flow chart of a method of manufacturing an insulating mat according to an aspect of the present invention; and

FIG. 11 is a flow chart of a method of manufacturing an insulating mat according to another aspect of the present invention.

### DETAILED DESCRIPTION

For impact sound application, one of the design rules of sound insulating materials is to use low dynamic stiffness material to ensure sufficient springiness of the material under compression force (Migneron and Migneron 2013). The dynamic stiffness is an intrinsic property of a material that depends on its components and its structure. To reduce the apparent dynamic stiffness of a defined material, one way is to reduce the number of contact points with the surface of the construction materials placed in the “sandwich assembly”.

### Sound Insulating Mat

According to an aspect of the invention, there is provided an insulating mat for floor-ceiling assembly sound insulation. In some embodiments, the mat comprises at least a layer of combined natural fibers-binder web. The web thus comprises both natural fibers and a binder.

The natural fibers may comprise wood or annual plant fibers from any suitable source known by the skilled practitioner. For example, the natural fibers may be virgin fibers from wood chips, sawdust, plants, and agricultural residues. They may also be other non-virgin biomass such as recycled fibers from recycled paper or recycled corrugated cardboard. In some embodiments, the natural fibers are ground wood fibers, flax fibers, hemp fibers or any other type of annual plant fibers. They may be produced by any method known by the skilled practitioner, such as medium density fiberboard process, mechanical pulping, thermomechanical pulping, chemi-thermomechanical pulping, and chemical pulping or may be market available fibers. It will be understood by the skilled practitioner that the natural fibers may comprise any combination of the previously mentioned fibers. To obtain individualized natural fibers, the natural fibers source (such as dry wood or plant fiber pulp, pulp dry lap, or paper) can be treated by a hammer mill, shredder or fluffing system.

In some embodiments, the binder comprises synthetic fibers such as polypropylene, polyethylene, bicomponent fibers, polylactic acid, polylactide or any other synthetic fibers known by the skilled practitioner. The binder may also comprise other binding material such as latex for example.

In some embodiments, the weight ratio of natural fibers to binder is in the range of 95/5 to 60/40, i.e. the web comprises from 95 to 60 wt. % of natural fibers based on the total weight of the web, and from 5 to 40 wt. % of binder based on the total weight of the web. In a preferred embodiment the weight ratio is in the range of 95/5 to 70/30.

In some embodiments, the natural fibers used in the insulating mat are chemically and/or bio-chemically pre-treated for water resistance, fire resistance, mold or decay resistance. Such functionality treatments, using various chemicals, are applied to the natural fibers prior to produce the insulating mat and allow protecting the mat against water, fire, or fungal growth alteration.

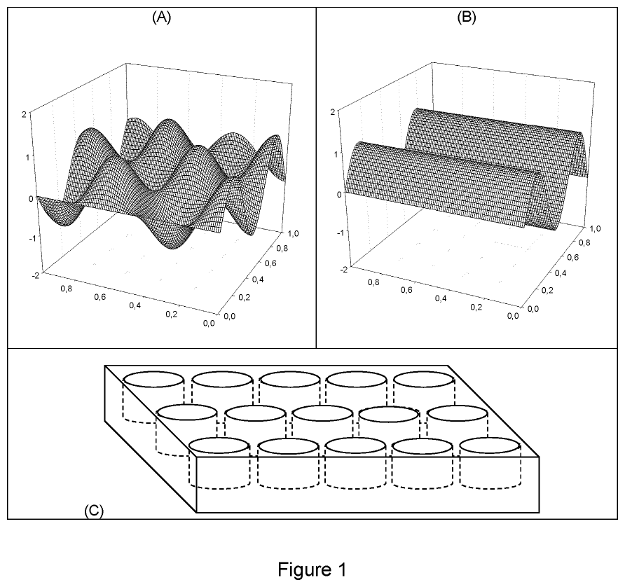

The web has a thickness and at least an upper surface and a lower surface opposite each other. As illustrated in FIG. 1, at least one of the upper and lower surfaces can have an uneven profile in cross-section through the thickness of the web to achieve even better impact sound insulation than the flat mat having the same thickness. As understood by the skilled practitioner, a cross-section is the intersection of a body in 3D with a plane. This produces a profile having lines corresponding to the external surface of the body. An even cross-section through the thickness, or thickness cross-section, refers to a cross-section wherein the intersecting plane is substantially perpendicular to both the upper and lower surfaces defining the thickness of the body (here the insulating mat). The cross-section in thickness of a flat mat would therefore comprise an upper linear profile and a lower linear profile (both straight and continuous lines) opposite to each other and corresponding to the flat upper and lower surfaces.

According to the present invention, an uneven cross-section profile in thickness comprises at least an irregular line corresponding to one of the upper and lower surface of the mat. The line may be discontinuous, non-linear, saw-toothed, wavy, or a combination thereof. Referring to FIG. 1(A), an embossed web according to the invention comprises at least one of the upper and the lower surfaces with an uneven profile having undulations spreading in two directions. FIG. 1(B) shows another embossed web wherein at least one of the upper and lower surfaces comprises an uneven undulated profile, wherein the undulations spread in one direction. Finally, in FIG. 1(C) the web is perforated and the upper and lower surfaces have discontinuous profiles that define holes in the mat.

With a flat web, having even profiles in cross-section in thickness, the upper and lower surfaces are in continuous contact with the adjacent construction materials of a sound insulating assembly. On the contrary, a web having an uneven cross-section profile in thickness has deformations in relation to thickness or depth, thereby limiting the number of contact points with the construction materials. The uneven profile of the thickness cross-section reduces the dynamic stiffness of the insulating mat and improves the impact sound insulation performance when compared to the dynamic stiffness and sound insulation performance of insulating mat having exclusively flat cross-section profiles in thickness.

The uneven profile comprises deformations with protuberances and cavities. The top of the protuberance will be in contact with the adjacent material in a noise control system. The deformations may include lumps, indentations, holes, contours, two-dimensional grooves, three-dimensional sinusoidal surfaces, parabolas, or spot bonding. A combination of forms or shapes can be used for the same web. For example, FIG. 1(A) shows a 3D sinusoidal surface, FIG. 1(B) corresponds to a sinusoidal surface (or grooves), and FIG. 1(C) presents a perforated mat. Holes may be formed using a subtracting process, and the subtraction projection (the shape of the hole) may be of any shape such as round, square, rectangular or any other geometric forms. In addition, the deformations on the web may form a repeating regular pattern or a random pattern. For example, the disposition of the holes may be in a regular pattern (such as square or hexagonal arrangement for instance), in a random pattern or in a combination of regular and random patterns. In some embodiments the amplitudes of the deformations from the top of the protuberance to the bottom of the cavities is of at least 15% of the insulating mat thickness.

In some embodiments, the web is flexible and malleable, lending itself to conversion into different shapes or profiles even after consolidation. Several methods known by the skilled practitioner may be applied to convert permanently the profile of contact surface of the web.

In some embodiments, the web has a bulk density in the range of 40 to 150 kg/m³. Preferably, the density is in the range of 40 to 80 kg/m³. It is important to note that deformations such as two-dimensional grooves, three-dimensional sinusoidal surfaces, parabolas, or spot bonding creates local high density points, as illustrated in FIGS. 1(A) and (B).

In some embodiments, the natural fibers used in the web are mechanically treated, i.e. are cut in small strands prior to be mixed with the binder. More particularly, wood fibers such as market pulp, or agricultural fibers can be shredded prior to be used in the web.

The insulating mat may also be post-treated for water, vapor, or moisture protection. The post-treatment may be present on one or both surfaces of the insulating mat. In some embodiments, the insulating mat comprises a laminated film that is water resistant such as low-density or high-density polyethylene, or a metallic film such as aluminum on one or both surfaces. Alternatively, the insulating mat may be coated or impregnated with chemicals that convey water or moisture resistance. Alkyl ketene dimer, fluorocarbon, siloxanes, waxes or any other chemical providing water and moisture resistant, may be used depending on the end requirement of the application.

In some embodiments, the insulating mat comprises one layer of combined fibers-binder web. This layer is stacked between other materials composing a noise control system in buildings or transportations. Alternatively, the insulating mat may comprise more than one layer. It may comprise several layers of combined fibers-binder web such as defined herein, or it may comprise different layers stacked together. For example, the insulating mat could be a multilayer mat wherein layers of fiber matrices with either flat surface or even cross-section profile can be alternated with a web having an uneven cross-section profile in thickness as described herein. The insulating mat layers may also be produced using any of the deformation process discussed herein. The skilled practitioner will understand that the stacked layers may be bound using any adhesive.

In some embodiment the insulating mat is a footfall mat that provides sound insulation for impact noise such as footfall, items hitting the floor, where the impact results in vibrations being transferred through the buildings structure. An impact noise is a structural vibration, transmitted from a point of impact through a structure and experienced as radiated sound from a vibrating surface.

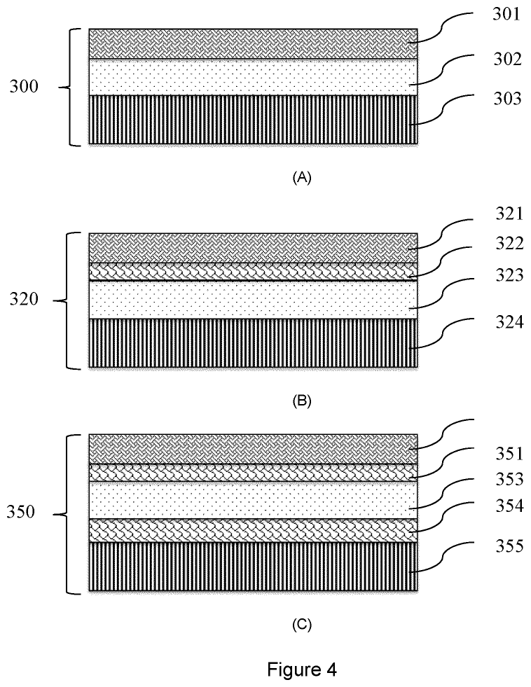

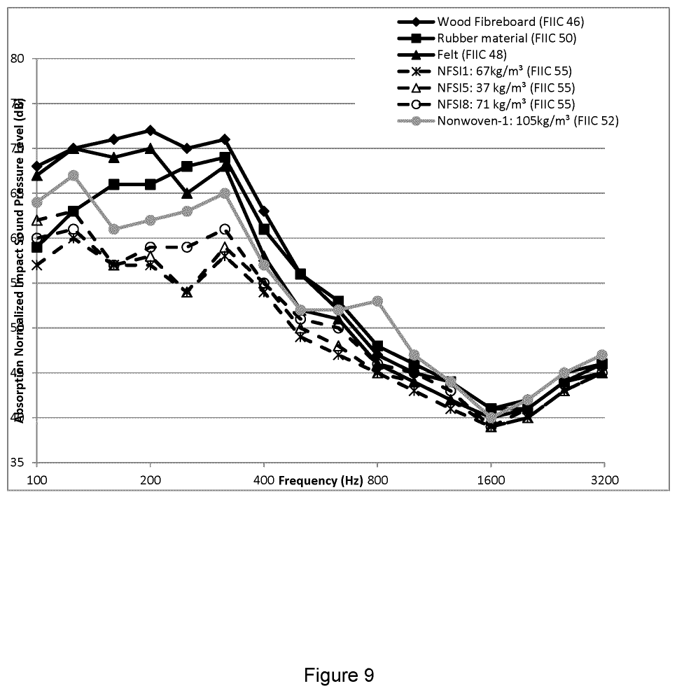

The insulating mat has insulation capacities superior to common insulating material generally used in buildings and transportation. FIG. 9 shows the absorption normalized impact sound pressure level (ANISPL) of wood fiberboard, rubber and felt insulating materials along with the ANISPL of insulating mats as described herein, installed in the noise control system III (FIG. 4). In FIG. 9, the ANISPL of the insulating mat according to the invention, between 125 and 400 Hz, i.e. at low frequencies, is lower than the ANISPL of the wood, rubber and felt-based materials. In some embodiments, the ANISPL of the insulating mat is below 65, more preferably between 50 and 65.

Tables 1(a), 1(b) and 1(c) below summarize the composition, properties and Absorption Normalized Impact Sound Pressure Level of the materials and insulating mat of FIG. 9.

TABLE 1(a)
Composition and properties of sound insulating mats of FIG. 9

| Sound | Thickness | Density | Fiber | Wood content |
|---|---|---|---|---|
| insulating mat | (mm) | (kg/m³) | type | (%) |
| NFSIM1 | 16.9 | 67 | MDF | 70 |
| NFSIM5 | 15.1 | 37 | MDF | 80 |
| NFSIM8 | 16.4 | 71 | BCTMP | 90 |
| Nonwoven-1 | 15 | 105 | MDF | 60 |

TABLE 1(b)
Composition and properties of common
insulating materials of FIG. 9

| | | Thickness | Density |
|---|---|---|---|
| Commercial name | Material type | (mm) | (kg/m³) |
| BP Canada | Wood fiberboard | 13.5 | 243 |
| Insonomat | Rubber | ~15 | ~300 |
| Therma Son VB | Recycled synthetic | 6.0 | 110 |
| | fiber felt with plastic | | |
| | film lamination | | |

TABLE 1(c)
Absorption Normalized Impact Sound Pressure Level (dB) of common
insulating materials and sound insulating mats of FIG. 9

| | Wood | Rubber | | NFSIM1: | NFSIM5: | NFSIM8: | Nonwoven-1: |
|---|---|---|---|---|---|---|---|
| Frequency | Fiberboard | material | Felt | 67 kg/m³ | 37 kg/m³ | 71 kg/m³ | 105 kg/m³ |
| (Hz) | (FIIC 46) | (FIIC 50) | (FIIC 48) | (FIIC 55) | (FIIC 55) | (FIIC 55) | (FIIC 52) |
| 100 | 68 | 59 | 67 | 57 | 62 | 60 | 64 |
| 125 | 70 | 63 | 70 | 60 | 63 | 61 | 67 |
| 160 | 71 | 66 | 69 | 57 | 57 | 57 | 61 |
| 200 | 72 | 66 | 70 | 57 | 58 | 59 | 62 |
| 250 | 70 | 68 | 65 | 54 | 54 | 59 | 63 |
| 315 | 71 | 69 | 68 | 58 | 59 | 61 | 65 |
| 400 | 63 | 61 | 58 | 54 | 55 | 55 | 57 |
| 500 | 56 | 56 | 52 | 49 | 50 | 51 | 52 |
| 630 | 52 | 53 | 51 | 47 | 48 | 50 | 52 |
| 800 | 47 | 48 | 46 | 45 | 45 | 46 | 53 |
| 1000 | 45 | 46 | 44 | 43 | 44 | 45 | 47 |
| 1250 | 44 | 44 | 42 | 41 | 42 | 43 | 44 |
| 1600 | 41 | 41 | 40 | 39 | 39 | 39 | 40 |
| 2000 | 42 | 41 | 41 | 40 | 40 | 41 | 42 |
| 2500 | 45 | 44 | 44 | 43 | 43 | 44 | 45 |
| 3150 | 46 | 46 | 45 | 45 | 45 | 45 | 47 |

The insulating mat is compressible under stress and allows decreasing the vibration transmission within the floor-ceiling assembly. In some embodiments, the insulating mat is also flexible and can be in the form of a roll, sheet or mat of different thicknesses and densities for various applications, and for ease of transportation and installation. Table 2 summarizes the most preferred properties of sound insulating mats that are flat with an even surface profile prior to converting into deformed insulating mat.

TABLE 2
Most Preferred Attributes of Natural Fiber Sound Insulating Mats

| Attributes | Units | Range |
|---|---|---|
| Dynamic stiffness | MN/m³ | 5-83 |
| Loss factor | — | 0.11-1.15 |
| Noise reduction coefficient (NRC) | — | 0.05-0.35 |
| Compression Young modulus | kPa | 12-130 |
| Open porosity | % | 80-97 |
| Airflow resistivity | KPa · s/m² | 24-527 |

### Method of Manufacturing the Insulating Mat

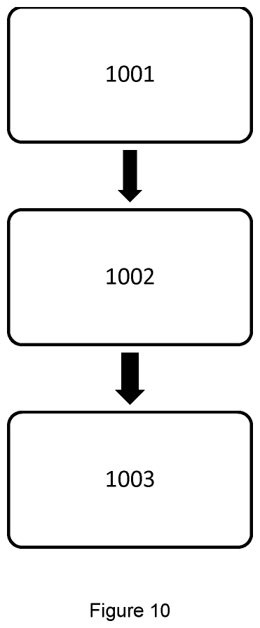

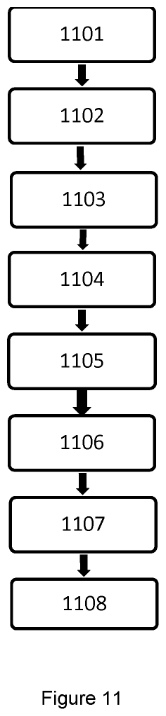

According to another aspect of the invention, and referring to the diagram of FIGS. 10 and 11, there is provided a method for manufacturing an insulating mat as described herein. According to the block diagram of FIG. 10, the method comprises the steps of opening and blending pre-treated natural fibers and a binder (1001), forming a web from the natural fiber-binder mixture (1002) and processing the web to produce a web having an uneven non-linear cross-sectional profile (1003). Opening the fibers may be done using a fiber opener. In some embodiments, opening and blending the fibers is done using the same equipment, such as an opening and blending machine. In some embodiments, and based on the total weight of the web, the natural fibers represent 60 to 95 wt. % and the binder represents 5 to 40 wt. %.

Once the fibers are opened and blended, the natural fibers-binder web is formed from the mixture of natural fibers and the binder. Various web-forming processes may be used in this step. For example, the web may be done by an air-laid process, or a carding process. Dry-laid technology platforms with both vertical and horizontal fiber orientation capacity may be used to manufacture the insulating mat. The resulting web has a bulk density of 40 to 150 kg/m³, preferably of 40 to 80 kg/m³

The natural fibers used in the present method are pre-treated with functional chemicals to achieve water resistance, fire resistance, and mold or decay resistance properties. The pre-treatment may be done at different stages of the process either during the production of fibers or during the fiber opening. The natural fibers used in the present method may alternatively be provided already pre-treated.

The method then comprises processing the web to produce a web having at least one uneven cross-section profile in thickness. Various deformation processes may be used in this step. In some embodiments, the structure of the web can be modified by conversion technique such as embossing, calendaring, perforating, punching or thermal point bonding. More particularly, the deformation process could be, but is not limited to, cold calendaring, hot embossing, thermal point bonding, one-side embossing, two-side embossing, tip-to-tip embossing, hole-making embossing or stamping of the web. In some embodiments, after a first consolidation step, the material may be calendared and/or shape-formed via a continuous process.

One aspect of the processing step is to provide permanent protuberances and cavities inducing deformations in relation to thickness or depth thereby limiting the number of contact points with the construction materials. The shape could take any form as long as it allows reduction of the number of contact points between the sound insulating mat and the surface of the adjacent construction material placed in a “sandwich assembly” acting as a noise controlling system. Common shapes may be applied such as two-dimensional grooves, three-dimensional sinusoidal surfaces, parabolas, or random spot bonding. However, it is understood that other shapes may be possible. This step involves the formation of a durable contour on at least one surface of the natural fiber sound insulating mat.

In some embodiments, subtractive manufacturing techniques may be used to reduce the number of contact points of the sound insulating mat with the surface of the adjacent construction material. Any subtractive method may be used such as, but not limited to, hole punching, hole embossing, hole piercing, die cutting, perforating or slotting. The subtraction projection on the material surface may be of any shape. For example round, square, rectangular or any other geometric forms may be applied. A combination of shapes may also be used on the same web. In addition, the disposition of the subtractions projections may be in a regular pattern (square, hexagonal or any other arrangement), in a random pattern or in a combination thereof.

Now referring to the block diagram of FIG. 11, additional optional steps may be added to the method. As mentioned herein, the natural fibers are pretreated, so that pre-treating untreated natural fibers may be an additional step to the method. In FIG. 11, pre-treating the natural fibers (1101) occurs before an opening and blending natural fibers and binder (1103) step. However, the pre-treatment may be done at any time before forming the web (1104). In some embodiments, the method further comprises shredding the natural fibers (1102) before forming the web.

In some embodiments, as illustrated in FIG. 11, after web forming (1104), the method comprises consolidating the web (1105). In the case an air-laid process is used, the fibers in the web may be consolidated for instance by thermal bonding in hot air-through dryer. In the case a carding process is used, the web is cross-lapped and needle punched. In the latter scenario, the target thickness and density of the fiber mat are adjusted by the needle punch frequency and line speed.

Still referring to FIG. 11, the method further comprises post-treating the manufactured insulating mat (1107). For example, the insulating mat may be post-treated by coating or lamination to ensure water or vapor barrier properties on one or both surfaces of the insulating mat. For example, post-treating the insulating mat may comprise laminating with a film that is water resistant such as low density or high-density polyethylene, or metallic films such as aluminum. Alternatively, the method may comprise coating or impregnating the insulating mat with chemicals that convey water or moisture resistance, such as alkyl ketene dimer, fluorocarbon, siloxanes, or waxes. The use of any particular chemicals depends on the end requirement of the application.

In some embodiments, the method further comprises bonding the layer of combined natural fibers-binder web to at least another additional layer (1108). The resulting insulating mat is therefore a multilayer mat. The additional layer may be a combined natural fiber-binder web such as described in the present application, or may be a flat layer, a web having an even cross-section.

Finally, the method of manufacturing the insulating mat may comprise a drying or curing step (not shown in the diagram of FIG. 11). Once produced, and/or converted and/or post-treated, the sound insulating mat described herein can be trimmed, rolled and packaged. Depending of the final application, the roll of sound insulating mat can also be cut to the desired size and then packaged. The sound insulating mats are then ready to be used independently as sound insulating mat or within the design of Noise Control Systems.

### Noise Control System

Sounds are vibrations through a gas, liquid or elastic solid with frequencies of approximately 20 to 20,000 Hz capable of being detected by the human ear. Noise is a sound that is undesired. Resonance is an intensification or prolongation of the sound, which occurs in poorly designed air cavities. Noise is considered as a form of energy, an effective strategy for controlling noise transmission is to gradually attenuate the energy at the source, along the path and at the receiver. In building, transportation or other applications, noise is caused by several factors: the initial vibration of air (e.g. talking), initial vibration of the elastic solids (e.g. footsteps), subsequent vibration of the air and/or elastic materials, and resonance or intensification of the sound energy by the air cavities. To attenuate the energy of sound, three lines of defense may be implemented to: 1) reflect noise back to the source or absorb the impact force, 2) to attenuate vibration of the material elements of the partition such as wall or floor and resonance in the partition cavities, and 3) to prevent further vibration of the partition elements into the receiving room. To have three lines of defense in a building partition, the material elements chosen are critical as they each have an important sound attenuation function. For floors, these materials can include a combination of one or more floor finishes, one or more invented sound insulating mat, a heavy mass such as topping, a structural floor with a decoupled ceiling from the structural floor.

According to a further aspect of the invention there is provided a noise control system comprising the sound insulating mat as described herein. In some embodiments, the noise control system comprises at least three layers. Beside the insulating mat, the noise control system comprises at least two supplementary layers of material for floor-ceiling assembly. The supplementary layers may be a floor finish, a topping, and a structural floor. In some embodiment, the noise control system comprises a footfall mat under the finish according to the present invention, for impact noise insulation, and two of the above-mentioned additional layers.

Rigid floor finish includes but is not limited to wood laminated floor finish, hardwood floor finish, ceramic and masonry tiles, decorative concrete, and marble. A topping is the material placed on the top of structural floors to increase the weight of light frame floors that in turn improves the floor sound insulation. Common topping materials include thick composite wood panels, cement-fiber boards, gypsum boards, and various wet concrete poured on-site. Concrete is a composite material composed of aggregate bonded together with fluid cement, which hardens over time. Types of concrete may vary depending on the composition of the mixture, the chosen density, and its targeted application. The types of concrete used in the topping referred to in this document include gypcrete of at least 1200 kg/m³, lightweight concrete of at least 1800 kg/m³, and normal weight (regular) concrete of at least 2300 kg/m³.

As illustrated in Table 3 below, and contrary to most of existing sound insulation products in the market, the sound insulating mat as described herein may act in each of the three lines of defense.

TABLE 3
Roles of the sound insulating mat in three-
line defense assemblies for noise control

| Defense Line | Role of Sound Insulating Mat |
|---|---|
| First | Impact force absorber placed under a rigid floor finish |
| Second | Vibration isolator placed under a topping |
| Third | Impact sound absorber and resonance damper placed in |
| | partition wall cavities or floor-ceiling cavities |

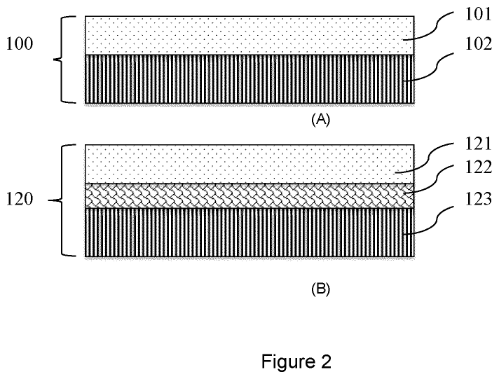

Referring to FIGS. 2 to 4, different configurations may be possible, for example, the insulating mat may be inserted between a topping and a structural floor. FIG. 2(B) shows a noise control system for Wood or Wood-Hybrid Buildings comprising an insulating mat (122) as defined herein between a topping (121) and a wood structural floor (123). A control reference system is provided in FIG. 2(A), wherein a topping (101) was directly placed on the top of the wood structural floor (102) without the insulating mat.

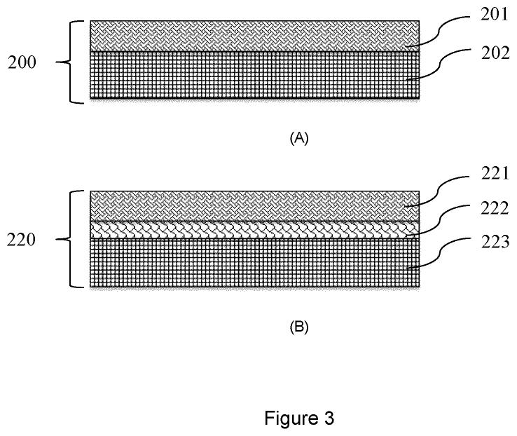

FIG. 3(B) shows a noise control system for Wood, or Wood-Hybrid or Non-Wood Buildings comprising an insulating mat (222) as defined herein between a rigid floor finish (221) and a wood or concrete structural floor (223). A control reference system is provided as indicated in FIG. 3(A), wherein a rigid floor finish (201) was directly placed on the top of a wood based or concrete floor (202) without the insulating mat.

FIG. 4(B) shows a noise control system for Wood or Wood-Hybrid Buildings comprising an insulating mat according to the invention (322) between a rigid floor finish (321) and a topping (323) placed on a wood or concrete structural floor (324). A control reference system is provided as indicated in FIG. 4(A), wherein a topping (302) was directly put on the top of the wood structural floor (303), on top of the topping was a rigid floor finish (301) without the insulating mat.

In some embodiments, the noise control system comprises more than 3 layers, and more particularly, the noise control system may comprise more than one layer of insulating mat as described herein. The insulating mats may be alternated with other material as mentioned herein.

FIG. 4(C) shows a noise control system comprising a first insulating mat (352) as defined herein between a rigid floor finish (351) and a topping (353) and a second insulating mat (354) placed between the topping (353) and a wood structural floor (355).

In the previous particular noise control systems, floor finish, the topping and the structural floor may be made of any material for buildings or transportation, such as wood concrete or the like.

The noise control system reduces impact sound transmission in floor-ceiling assemblies for Wood buildings, Wood-Hybrid buildings or non-Wood buildings. In order to quantify building acoustic performance, standardized tests can be performed. One of the standardized test methods, ASTM E1007, indicates how to quantify impact sound insulation performance in the field using a tapping machine installed on a floor-ceiling assembly in a building or a model building. The test also can be performed in an acoustical chamber using ASTM E492. The basic principle of the test is to generate impact forces with a standardized ISO tapping machine on the floor-ceiling assembly in the source room while measuring, in the receiving room below, the sound pressure levels at sixteen specified frequencies from 100-3150 Hz. The resulting data (sound pressure levels according to frequency) can then be transformed into a single number rating called Field Impact Insulation Class (FIIC) using the ASTM E989 procedure depending on where to perform the test. The lower the sound pressure levels in the receiving room, the higher the FIIC rating of the floor-ceiling assembly which in turn indicates a better impact sound insulation. It should be pointed out that a three point or more improvement in FIIC is considered significant because such an improvement will be perceived by most of the room occupants.

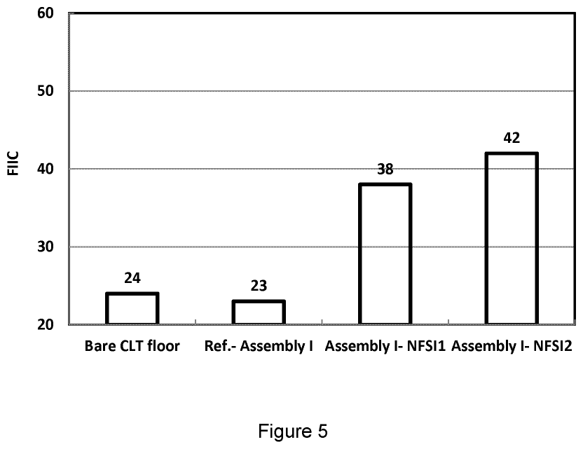

FIGS. 5 to 8 show FIIC values of the control reference system and/or commercial noise control systems compared to that of the noise control systems comprising at least one insulating mat according to the invention. It appears that using the sound insulating mat of the present invention as a vibration isolator placed between a heavy rigid concrete topping and a wood structural floor increased the floor FIIC by 15-19 points in comparison to the control reference system (see FIG. 5). FIG. 5 presents the FIIC values of a bare Cross Laminated Timber (CLT) floor, the control reference system (Ref.-Assembly I) of FIG. 2 and two noise control system according to the present invention (Assembly I-NFSIM1 and Assembly I-NFSIM2).

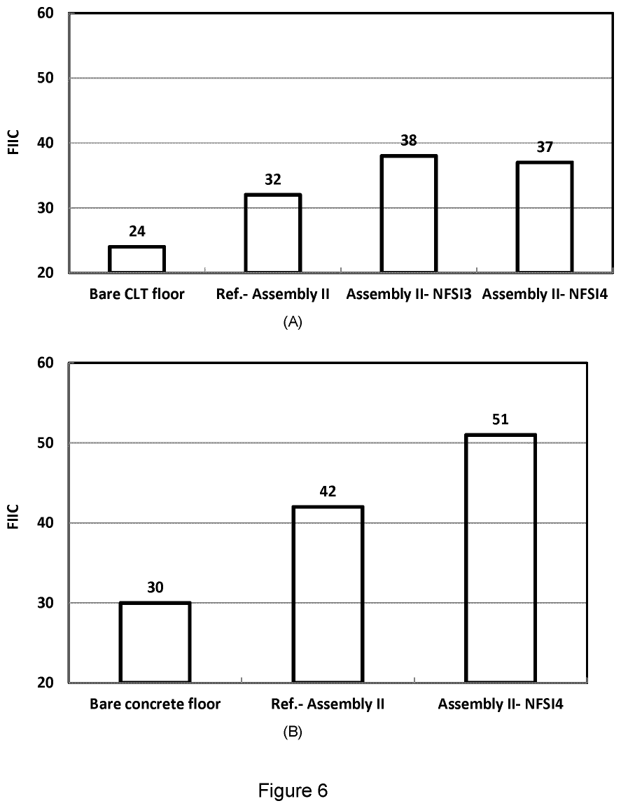

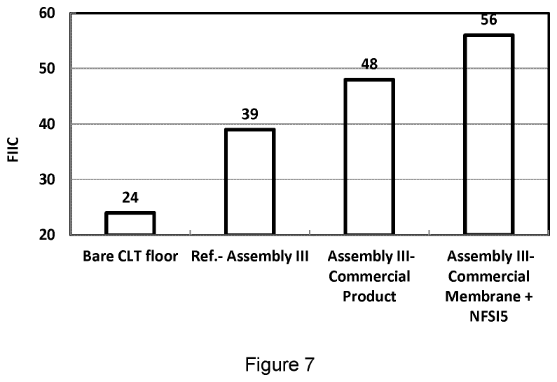

In addition, using the sound insulating mat as an impact force absorber placed between wood floor finish and a concrete structural floor or between wood floor finish and a wood structural floor increased the FIIC by 5-6 points for wood structural floor and 4 points for concrete structural floor (FIGS. 6(A) and (B)) in comparison with the control reference system (Ref.-Assembly II) of FIG. 3(A). FIG. 6(A) presents the FIIC values, for a structural wood floor, with the bare CLT floor, the control reference system and noise control systems (Assembly II-NFSIM3 and Assembly II-NFSIM4) of FIG. 3(B) according to the present invention. FIG. 6(B) presents the FIIC values, for a structural concrete floor, with a bare concrete floor, the control reference system (Ref.-Assembly II) of FIG. 3(A) and of a noise control system (Assembly II-NFSIM4) of FIG. 3(B) according to the present invention. Finally, using the sound insulating mat as a vibration isolator and an impact force absorber, the impact sound insulation performance of the noise control system was superior to the existing commercial products, and the measured FIIC is 16 points higher than the control reference system (Ref.-Assembly III), and 7 points higher than the system using commercial products (FIG. 7). FIG. 7 presents the FIIC values of a bare wood CLT floor, the control reference system (Ref-Assembly III) of FIG. 4(A), a noise control system with commercial product and a noise control system with the insulating mat according to the present invention (Assembly III-NFSIM5).

In some embodiments, the noise control system has a FIIC of between 38 and 56. The FIIC value depends notably on the building structure (wood, concrete, hybrid), the thickness of the materials (finish, structural floor, topping . . . ), the density of the materials, the floor-wall connections, the floor finish type, the ceiling insulation (acoustic tiles, resilient mounting . . . ), the number of layers used, the nature of the remaining layers, the natural fibers type, the content of natural fibers, the density of the insulating mat, the thickness of the insulating mat and the quality of construction.

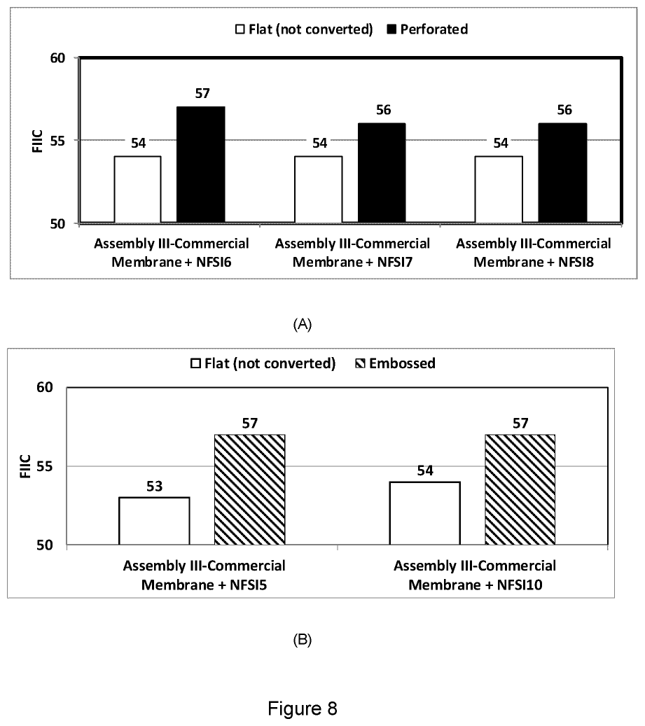

By changing the profiled surface shape and/or by changing the number of contact points of the sound insulating mat surface with the adjacent construction material surface, the resulting lower dynamic stiffness of the sound insulating mat provides a better acoustic performance. FIG. 8 presents the FIIC results comparing flat insulators and insulating mats having uneven cross-section profile according to the invention. In FIG. 8(A) three sound insulating mats according to the invention (NFSIM6, NFSIM7 and NFSIM8) have been modified by perforation. In FIG. 8(B) two sound insulating mats (NFSIM5 and NFSIM10) have been modified by hot embossing to provide a 3D sinusoidal shaped surface. It has been found that reducing the number of contact points on the surface of the sound insulating mats whether through material subtraction or through embossing increased the FIIC by 1 to 2 points when placed in a particular noise control system.

As mentioned above, FIG. 9 presents frequency spectrums (1-3 octave) of insulating materials in the noise control system of FIG. 4: wood fiberboard, rubber, felt, NFSIM1, NFSIM5, NFSIM8 and a nonwoven material. FIG. 9 shows that the decibel sound curves are all lower for the sound insulating mat according to the invention over the entire frequency range. More particularly, a particular signature is observable between 125 Hz to 400 Hz where the sound pressure levels drop by a maximum of 16 dB. As stated in the prior art, these low-frequency sounds are usually described as more annoying and stressful by the building occupants. These lower sound pressure levels at low frequency indicate that the sound insulating mat, when placed in a noise control system, behave differently when compared to commercially available impact sound insulating materials. This behavior will result in a better sound insulation for the occupants.

According to another aspect of the invention there is provided the use of the noise control system as described herein for floor-ceiling assembly insulation. The use of the noise control system allows reducing noise transmission in buildings or transportation. For example the noise control system may comprise a footfall mat that provides insulating against impact force applied on the floor-ceiling assembly.

For example, the floor finish and the sound insulating mat form the first line of defense to reduce the amount of impact force from the source that is transmitted to the structure floor. The heavy mass of the topping along with the sound insulating mat form the second line of defense to further reduce the amplitude of the vibration taking place in the floor-ceiling assembly. The sound insulating mat in the cavity along with the second floor finish such as decoupled drywall under the structural floor together forms the third line of defense. This serves to absorb the air resonance in the cavity and thereby finally prevents the noise to radiate to the room below. Therefore, the insulating mat comprised in the noise control system acts for reducing the sound propagation through the floor to the drywall ceiling, reducing amplitude of vibration of the base floor-ceiling assembly, absorbing air resonance in the floor-ceiling cavity, and decoupling vibrations with each other in the floor-ceiling assembly. If the sound insulating mat is used as a vibration isolator, it is important to select a material having a low dynamic stiffness that is able to isolate the vibration from the topping to the base floor. The noise control system according to the invention achieves superior impact sound insulation performance especially in the lower frequency range when compared to the same floor assemblies using commercially available insulating materials. This addresses the critical issue of wood floor systems naturally having poor low frequency sound insulation performance.

In some embodiments, the sound insulating mat according to the invention may be used as air-borne sound insulation with or without post treatment for wall or floor cavity and other building assemblies. It may also be molded as automobile sound insulation applications.

### EXAMPLES

The following examples are presented to describe the present invention in more details and to carry out the method for producing and designing of the sound insulating mat (also referred to as natural fiber sound insulating mat, NFSIM or isolator) and Noise Control Systems. These samples should be taken as illustrative and are not meant to limit the scope of the invention.

### Example 1: Manufacturing Natural Fiber Sound Insulating Mat by Air-laid Machine

### Step 1: Preparation of Natural Fibers

Different kinds of natural fibers can be used directly to manufacturing sound insulating mat. The fibers can be chemically treated prior to the manufacturing of sound insulating mat to achieve certain functionality. For water resistance, the fibers can be coated with wax or alkyl ketene dimer. For mold and decay resistance as well as for fire resistance, the fibers can be coated with zinc borate or octoborate tetrahydrate.

The raw materials used were softwood wood chips (black spruce or jack pine) which were provided by an eastern Canadian sawmill or softwood chemically-treated thermomechanical pulp (CTMP) fibers produced by a western Canadian manufacturer. The chemicals used were emulsion wax (Cascowax EW58), alkyl ketene dimer (Kemira), zinc borate (Sigma-Aldrich), octaborate tetrahydrate (20 Mule team) and Acrodur (BASF).

The fibers were produced and treated with an Andritz pressurized refiner (22″ disc refiner with 160 kW motor and variable speed drive of up to 3600 rpm) equipped with a digester, an injection blow line and a flash tube dryer (90 m length, 4 million BTU/h natural gas burner). The setting of the refiner was adjusted to produce fibers typically used for medium density fiberboard (MDF) manufacture. The fibers were marked as MDF in this invention. The CTMP fibers also can be chemical treated at the blow line injection point of the refiner.

The softwood chips or the shredded CTMP are loaded into the pre-steaming bin and then the steam is applied into the system. The chips are transported through the feeding screw into the digester. Once a plug is formed, the system is pressurized with steam of up to 101 psi and a temperature of 170° C. After 2 minutes of residence time in the digester, the material is passed through the disc refiner operating at desired rpm with an adjustable plate gap distance. At the stabilized process condition, the chemicals can be injected into the blow line at the loading rates given in Table 4. Three pumps are used for the injection of the chemicals. Each pump is set to the condition for each individual chemical based on their loading rate. Eventually, the fibers are dried in the flash tube dryer to moisture content below 8%.

TABLE 4
Chemical Formulations for the MDF and
CTMP Fiber Preparation and Treatment

| | Chemicals (% weight based on dry wood fiber weight) | | | | |
|---|---|---|---|---|---|
| | | | Octaborate | Zinc | |
| Sample Code | AKD | Wax | Tetrahydrate | Borate | Acrodur |
| Ref | — | — | — | — | — |
| MDF-A-DoCu | 1 | | 2 | — | — |
| MDF-W-ZB-Ac | — | 1 | — | 5 | 12 |
| CTMP-A-ZBCC | 1 | — | 2 | — | — |
| CTMP-W-ZB-Ac | — | 1 | — | 5 | 12 |

### Step 2: Manufacturing Sound Insulating Mat by an Air-Laid Machine

Two kinds of MDF fibers have been produced with two fiber size distribution ranges from Step 1. Short MDF (MDF-S) fibers which were produced at a refiner speed of 2250 rpm and at a plate gap distance fixed at 0.1 mm. On the other hand, long MDF (MDF-L) fibers were produced with a refiner speed of 1800 rpm and a plate gap distance fixed at 1.5 mm. The two types of fibers were used to produce sound insulating mats with an air-laid process. A wide range of wood/agriculture/synthetic fiber ratios were used to produce mats and boards of different basis weight and thickness. The various samples manufactured during Trial 1 and their fiber formulations are summarized in the first part of Table 4 below.

In Trial 2, different wood fibers were prepared from MDF, bleached chemically treated thermo-mechanical pulp (BCTMP) and northern bleached softwood Kraft pulp (NBSK). MDF fibers were produced with the Andritz refiner as described in Step 1 at a speed of 2000 rpm and a plate gap distance at 0.2 mm. Modified MDF fibers were produced with similar refiner setting and EVA resin (copolymer ELVACE 735) was injected into the blowline to coat the fiber with a thermoplastic shell. In addition BCTMP and NBSK were shredded by a hammer mill. Then, the wood fibers were weighed and placed onto the conveyor belt for a given specific surface area prior to laying over of a known amount of bi-component fibers atop the wood fibers. These fibers were then fed into the fiber opener where the combined fibers were uniformly opened. The opened and blended fibers were fed to a 600 mm width air-laid former (FormFiber, Spike 600 Model, Denmark). After the formation, the continuous fiber mat with a given specific area density was passed through a thermo-bond oven at 180° C. with a residence time of 5 minutes. Final mat thickness was controlled by an application of a cold calendar press at the end of the oven. The fiber formulations of Trial 2 are presented in Table 5.

TABLE 5
Examples of Fiber Formulations for the Air-Laid materials with Different Natural Fibers

| | | Wood | Agriculture | Bicomponent | | |
|---|---|---|---|---|---|---|
| Sample | Wood | Fiber Ratio | Fiber Ratio | Fiber Ratio | Basis Weight | Thickness |
| Code | Fiber Type | (%) | (%) | (PET/PE) | (g/m²) | (mm) |
| Trial 1-1 | MDF-Short | 80-100 | — | 0-20 | 5000 | 100-200 |
| Trial 1-2 | MDF-Long | 60-80 | 10-20 | 10-20 | 300-5000 | 10-100 |
| Trial 2-1 | MDF | 60-90 | — | 10-40 | 240-1200 | 2-20 |
| Trial 2-2 | NBSK | 70-90 | — | 10-30 | 900-1200 | 10-20 |
| Trial 2-3 | BCTMP | 70-90 | — | 10-30 | 1000-1300 | 10-20 |

### Example 2: Manufacturing Sound Insulating Mat by a Carding Machine

Using the fibers produced from Step 1, the manufacture has been operated on a carding pilot line built by Automatex (Italy) located in Eastern Canada. The fibers prepared from the MDF pilot plant were blended with polypropylene or polylactic acid fibers based on the weight ratios given in Table 6. A small amount of agriculture fiber such as flax was added because of their longer fiber length that serves to carry the wood fiber through the carding process. The card equipped with 3 sets of worker-strippers opens the fiber bundles and produces a fiber web at about 10-15 m/min with an average weight of 30-40 g/m². The web is cross-lapped in the required amount of layers to achieve the desired weight of the final product. The cross lapped layers are submitted to a mechanical entanglement of barbed needles in a needle-punch loom where fibers are bonded together. The adjustment parameters are the frequency of needle strokes and depth of penetration that are both adjusted to get the desired web density. The average output speed is around 0.5-1 m/min and the fabric width is around 50 cm.

TABLE 6
Fiber and Binder Formulations for the Natural Fiber
Sound Insulating Mat Made by a Carding Machine.

| | Fiber | | Binder | | | |
|---|---|---|---|---|---|---|
| | (% wt.) | | (% wt.) | | Basis Weight | Thickness |
| Sample Code | MDF | Flax | PP | PLA | (g/m²) | (mm) |
| Carding-1 | 70 | — | 30 | — | 1092-1126 | 12.7-12.6 |
| Ref. | | | | | | |
| Carding-2 | 30 | — | 30 | — | 1126 | 12.2-12.7 |
| Carding-3 | 70 | 10 | 20 | — | 1613 | 12.1 |
| Carding-4 | 70 | 10 | — | 20 | 1506 | 10.6 |

### Example 3: Acoustical Performance of Selected Sound Insulating Mats, Used as Underlayment for a Topping, on Cross-Laminated-Timber Floor to Form a Noise Control System (No. 120, FIG. 2)

Flat surface profiled natural fiber sound insulating mat from this invention can be used with a topping as described in FIG. 2 by placing them between the wood floor and the topping to significantly reduce the impact noise transmission of wood-based floors in wood or wood-hybrid buildings.

Measurements were taken on a 175 mm thick cross-laminated-timber (CLT) floor in FPInnovations mock-up of a two-story wood building. The base floor has no ceiling. A 1.2 m by 1.2 m patch of the Noise Control System made of the flat surface profiled natural fiber sound insulating mat and a 38 mm thick concrete slab topping of 2052 kg/m³ was placed on the cross-laminated-timber floor. An ASTM standard test method E 1007 was first performed on the cross-laminated-timber floor (No. 102, FIG. 2(A)) with a concrete topping (No. 101, FIG. 2(A)): described as the control reference system (No. 100, FIG. 2(A)). Then the same tests were repeated by placing selected natural fiber sound insulating mats (No. 122, FIG. 2(B)) produced as described in Example 1, between the concrete topping (No. 121, FIG. 2(B)) and the CLT floor (No. 123, FIG. 2(B)). The results are illustrated in FIG. 5.

As it can be seen in FIG. 5, the floor with the noise control system I using the flat surface profiled natural fiber sound insulating mats (NFSIM 1 and 2) reach FIIC values of 38 to 42, which is 14-19 points higher than those obtained for the control reference system. Table 7(a) and 7(b) below give a summary of the composition and properties of the different sound insulating mats and noise control systems tested in example 3.

TABLE 7(a)
Composition and properties of sound insulating mats of example 3

| Sound | Thickness | Density | Fiber | Wood |
|---|---|---|---|---|
| insulating mat | (mm) | (kg/m³) | type | content (%) |
| NFSIM1 | 16.9 | 67 | MDF | 70 |
| NFSIM2 | 16.4 | 71 | BCTMP | 90 |

TABLE 7(b)
Composition and properties of noise control systems of example 3

| | Structural | | | | | |
|---|---|---|---|---|---|---|
| Noise control system | floor | Underlayment | Topping | Membrane | Finish | FIIC |
| Bare CLT floor | CLT | No | No | No | No | 24 |
| Ref.- Assembly I | CLT | No | Concrete slab | No | No | 23 |
| Assembly I-NFSIM1 | CLT | NFSIM1 | Concrete slab | No | No | 38 |
| Assembly I-NFSIM2 | CLT | NFSIM2 | Concrete slab | No | No | 42 |

### Example 4: Acoustical Performance of Selected Sound Insulating Mat, Used as Membrane, on Wood and Concrete Structural Floor to Form a Noise Control System, (No. 220, FIG. 3)

The disclosed sound insulating mat from this invention can be used to reduce the impact noise of wood based or concrete floors with a rigid floor finish as described in FIG. 3 (B). The sound insulating materials (No. 222, FIG. 3(B)) are placed between the wood based or concrete floor (No. 223, FIG. 3(B)) and the floor finish (No. 221, FIG. 3(B)) to form the Noise Control System (No. 220, FIG. 3) in wood, wood-hybrid or non-wood buildings.

For wood building, measurements were taken on a 175 mm thick cross-laminated-timber floor placed in FPInnovations mock-up of a two-story wood building. The base floor has no ceiling. A 1.2 m by 1.2 m patch of the Noise Control Assembly made of the natural fiber sound insulating mat and 12 mm thick wood floor finish was placed directly on the cross-laminated-timber floor. An ASTM standard test method E 1007 was first performed on the cross-laminated-timber floor with only the floor finish (No 201, FIG. 3(A)): described as the control reference system (No. 200, FIG. 3(A)). Then the same tests were repeated on the floor with the noise control system (No. 220, FIG. 3(B)). The results are illustrated in FIG. 6(A).

For concrete building, measurements were taken on a 205 mm thick concrete floor in a mock-up of a 2-story concrete building. The walls and floor were made of reinforced concrete of 200 mm and 205 mm, respectively. The base floor has no ceiling. A 1.2 m by 1.2 m patch of the Noise Control Assembly (No. 220, FIG. 3(B)) was made of 12 mm thick wood floor finish (No. 221, FIG. 3(B)), the natural fiber sound insulating mat (No. 222, FIG. 3(B)) was placed on the concrete floor (No. 223, FIG. 3(B)). An ASTM standard test method E 1007 was first performed on the concrete floor with only the floor finish: described as reference floor (No. 200, FIG. 3(A)). Then the same tests were repeated on the floor with the Noise control System. The results are illustrated in FIG. 6(B).

As it can be seen in FIG. 6, the FIIC values improved 5-6 points for the insulating mat compared to these of the control reference wood system (FIG. 6(A)) while the FIIC values improved by 4 points when compared to the control reference concrete system (FIG. 6(B)). Table 8 (a) and 8 (b) below give a summary of the composition and properties of the different sound insulating mats and noise control systems tested in example 4.

TABLE 8(a)
Composition and properties of sound insulating mats of example 4.

| Sound | Thickness | Density | Fiber | Wood |
|---|---|---|---|---|
| insulating mat | (mm) | (kg/m³) | type | content (%) |
| NFSIM3* | 5.2 | 74 | MDF | 80 |
| NFSIM4* | 3.1 | 141 | MDF | 60 |

TABLE 8 (b)
composition and properties of noise control systems of example 4

| | Structural | | | | | |
|---|---|---|---|---|---|---|
| Noise control system | floor | Underlayment | Topping | Membrane | Finish | FIIC |
| Bare CLT floor | CLT | No | No | No | No | 24 |
| Ref.-Assembly II | CLT | No | No | No | Flooring | 32 |
| Assembly II-NFSIM3 | CLT | No | No | NFSIM3 | Flooring | 38 |
| Assembly II-NFSIM4 | CLT | No | No | NFSIM4 | Flooring | 37 |
| Bare CLT floor | Concrete | No | No | No | No | 30 |
| Ref.-Assembly II | Concrete | No | No | No | Flooring | 40 |
| Assembly II-NFSIM3 | Concrete | No | No | NFSIM3 | Flooring | 51 |

### Example 5. Acoustical Performance of Selected Natural Fiber Sound Insulating Mats Used as Underlayment in Cross-Laminated-Timber Structural Floor for Form a Noise Control System (350, FIG. 4(C))

The sound insulating mat according to the invention can be used to reduce the impact noise of wood floors (No. 303, FIG. 4(A)) with a rigid floor finish (No. 301, FIG. 4(A)) and a topping (No. 302, FIG. 4(A)). The sound insulating mats (No. 354 and 352, FIG. 4(C)) are placed between the wood structural floor (No. 355, FIG. 4(C)) and the topping (No. 353, FIG. 4(C)) and between the floor finish (No. 351, FIG. 4(C)) and the topping to form a noise control system (No. 350, FIG. 4(C)) and to achieve optimized impact sound insulation.

Measurements were taken on a 175 mm thick cross-laminated-timber floor placed in FPInnovations mock-up of a two-story wood building. The base floor has no ceiling. A 1.2 m by 1.2 m patch of the Noise Control System made of the sound insulating mat, 12 mm thick wood floor finish and the 38 mm concrete slab topping of 2052 kg/m³ was placed on the cross-laminated-timber floor (No. 350, FIG. 4(C)). An ASTM standard test method E 1007 was first performed on the cross-laminated-timber floor with only the floor finish and the topping: described as control reference system (No. 300, FIG. 4(A)). Then the same tests were repeated on the floor with the Noise Control System. The results are illustrated in FIG. 7. On FIG. 7, the “Assembly III-Commercial Membrane+NFSIM5” is the bare CLT floor with the 12 mm laminated flooring and the concrete topping, sound insulating mat NFSIM5 or the commercial product was placed between the CLT floor and the topping, commercial membrane (AcoustiTech™ Premium) was placed between the floor finish and the topping.

As it can be seen in FIG. 7, the floor using the commercial underlayment (rubber mat) reached a FIIC value of 48. By placing the sound insulating mat according to the invention in the Noise Control System, the assembly reached FIIC value of up to 55 that outperform the commercial product. These results validate the floor Noise Control System using the disclosed sound insulating mat had superior impact sound performance when compared to the commercial products. Tables 9 (a) and 9 (b) below give a summary of the composition and properties of the different sound insulating mats and noise control systems tested in example 5.

TABLE 9(a)
Composition and properties of sound insulating mats of example 5.

| Sound | Thickness | Density | Fiber | Wood |
|---|---|---|---|---|
| insulating mat | (mm) | (kg/m³) | type | content (%) |
| NFSIM5 | 15.1 | 37 | MDF | 80 |

TABLE 9(b)
Composition and properties of noise control systems of example 5.

| | Structural | | | | | |
|---|---|---|---|---|---|---|
| Noise control system | floor | Underlayment | Topping | Membrane | Finish | FIIC |
| Bare CLT floor | CLT | No | No | No | No | 24 |
| Ref-Assembly III | CLT | No | Concrete | No | Flooring | 39 |
| | | | slab | | | |
| Assembly III-commercial | CLT | Insonomat | Concrete | AcoustiTech | Flooring | 48 |
| product | | (Rubber mat) | slab | Premiuim ® | | |
| Assembly III-Commercial | CLT | NFSIM5 | Concrete | AcoustiTech | Flooring | 55 |
| Membrane + NFSIM5 | | | slab | Premiuim ® | | |

### Example 6: Manufacturing Natural Fiber Sound Insulating Mats by Air-Laid Machine with Surface Coating

The samples produced in Example 1 were coated by an acrylic emulsion product named Roofskin from the company “Techniseal”. The coating was applied by a roller in 2 layers. The dynamic stiffness and the loss factor of the natural fiber sound insulating mats were measured by the ISO 9052-1 standard method and are presented in Table 10.

TABLE 10
Dynamic Stiffness and Loss Factor of Natural Fiber Sound insulating
mats with and without Acrylic Emulsion Coating.

| | Without Coating | With Coating |
|---|---|---|
| Dynamic Stiffness (MN/m³) | 5.8 | 6.3 |
| Loss Factor | 0.13 | 0.18 |

The small variation between the samples indicates that the impact sound insulation of the sound insulating mat is not significantly affected by the coating.

### Example 7: Manufacturing of Natural Fiber Sound Insulating Mat with Siloxane Impregnation

The samples produced in Example 1 were impregnated by an aqueous emulsion of a reactive polydimethylsiloxane (further simply referred as siloxane) named SILRES BS1042 from the company Wacker Chemie AG to provide water resistance. The sound insulating mat was immersed in a 2% emulsion (compared to fiber weight) during 2 hours. After drainage and drying, the dynamic stiffness and the loss factor of the natural fiber sound insulating mats were measured by the ISO 9052-1 standard method and are presented in Table 11.

TABLE 11
Dynamic Stiffness and Loss Factor of Natural Fiber Sound insulating
mats with and without Siloxane Emulsion Impregnation

| | Without Siloxane | With Siloxane |
|---|---|---|
| Dynamic Stiffness (MN/m³) | 5.8 | 5.4 |
| Loss Factor | 0.13 | 0.18 |

The small variation between the samples indicates that the impact sound insulation of the natural fiber sound insulating mat is not significantly affected by the impregnation.

### Example 8—Manufacturing Designed Uneven Cross-Section Profile Natural Fiber Sound Insulating Mats after the Web Forming Process

Natural fiber sound insulating mats have been produced as illustrated in Example 1. The insulating mat were then converted to insulating mat having an uneven cross-section profile by punching out holes with a 5 cm diameter round die. In order to reduce the number of contact points of the surface by 50%, the natural fiber sound insulating mat was punched such that the space from one hole center to another was 6.4 cm. The resulting flat even and uneven sound insulating mats were placed in the Noise Control System III and tested for FIIC. The results are displayed in FIG. 8(A) and Table 12.

TABLE 12
FIIC Comparing Flat Even Profiled Surface Natural Fiber Sound
Insulating Mats to Uneven Cross-Section Profiled Surface Natural
Fiber Sound Insulating Mats Made by the Hole Punch Method

| | FIIC | |
|---|---|---|
| Natural Fiber Sound insulating mat | Flat NFSIM | Uneven NFSIM |
| Airlaid MDF 1200 g/m² | 54 | 57 |
| Airlaid NBSK 1200 g/m² | 54 | 56 |
| Airlaid BCTMP 1200 g/m² | 54 | 56 |

As seen in Table 12, the reduced contact between the natural fiber sound insulating mat surface and the construction materials in Noise Control System (No. 350, FIG. 4(C)) improved the FIIC by 2 to 3 points for sound insulating mats comprised of three different natural fibers.

### Example 9: Manufacturing of Natural Fiber Sound Insulating Mats with Shaped Cross-Section Surface-Forming Conversion

Natural fiber sound insulating mats have been produced as described in Example 1. The insulating mats were then converted to insulating mats having an uneven cross-section profile by embossing one surface of the material to form a 3D sinusoidal shape (FIG. 1(A)). The sinusoidal shape reduced the number of contact points of the surface by approximately 20% before placement in the floor assembly. Embossing was accomplished by placing the flat even surface profile natural fiber sound insulating mat into a hot mold of 180° C. for 2 minutes. The resulting flat even and uneven sound insulating mats were placed in the Noise Control System (No. 350, FIG. 4(C)) and tested for FIIC. The results are displayed in Table 13 and FIG. 8(B).

TABLE 13
FIIC Comparing Flat Even Profiled Surface Natural Fiber Sound
insulating mats to Uneven Cross-Section Profiled Surface Natural
Fiber Sound insulating mats Made by the Hot Embossing Method

| | FIIC | |
|---|---|---|
| Natural Fiber Sound Insulating Mat | Flat NFSIM | Uneven NFSIM |
| Airlaid MDF 900 g/m² | 54 | 57 |
| Airlaid BCTMP 900 g/m² | 53 | 57 |

Table 13 shows that hot embossing improved the FIIC by 3 to 4 points. This improvement can be achieved for natural fibers sound insulating mats comprised of two different natural fibers.

### Example 10: Testing Different Contact Surface Coverage of Uneven Cross-Section Profile Natural Fiber Sound Insulating Mats after the Web Forming Process

NFSIM has been manufactured by airlaid process as described in Table 14.

TABLE 14
Composition of the NFSIM 11 and 12

| | Wood | | Basis | | |
|---|---|---|---|---|---|
| | Fibre | Bico | weight | Thickness | Density |
| NFSIM | type | Ratio | (g/m²) | (mm) | (kg/m³) |
| NFSIM11 | MDF | 10% | 900 | 15 | 60 |
| NFSIM12 | MDF | 10% | 1200 | 15 | 80 |

The materials were then cut in square pattern of 6×6 inches. The specimens were placed in the Noise Control System (No. 350, FIG. 4(C)) in order to test different surface coverage (namely 100%, 75%, 50%, 25% of the 4 by 4 feet concrete slab) and the FIIC was tested for each coverage. The results are shown in the Table 15.

TABLE 15
FIIC According to the Surface Coverage

| | Surface Coverage | |
|---|---|---|
| NFSIM | in Assembly III-Commercial Membrane | FIIC |
| NFSIM11 | 100% | 52 |
| | 75% | 54 |
| | 50% | 52 |
| | 25% | 50 |
| NFSIM12 | 100% | 51 |
| | 75% | 54 |
| | 50% | 49 |
| | 25% | 50 |

As seen in Table 15, the best FIIC is reached for a surface coverage of 75% with an increase of 2 or 3 points compared to the 100% surface coverage. Comparing the results from example 8 to 10, the modification of the even NFSIM to an uneven cross-section profile provides a significant gain in terms of impact sound insulation. The percentage of surface modification could be tuned to reach different FIIC.

Tables 16 (a) and 16 (b) below give a summary of the composition and properties of the different sound insulating mats and noise control systems tested in examples 8 and 10.

TABLE 16(a)
Composition and Properties of Sound
Insulating Mats of Examples 8 and 10.

| Sound | Thickness | Density | Fiber | Wood |
|---|---|---|---|---|
| Insulating Mat | (mm) | (kg/m³) | type | content (%) |
| NFSIM6 | 17.9 | 53 | MDF | 90 |
| NFSIM7 | 18.8 | 59 | NBSK | 90 |
| NFSIM8 | 16.4 | 71 | BCTMP | 90 |
| NFSIM9 | 14.8 | 52 | BCTMP | 80 |
| NFSIM10 | 16.4 | 54 | MDF | 80 |
| NFSIM11 | 15.0 | 60 | MDF | 90 |
| NFSIM12 | 15.0 | 80 | MDF | 90 |

TABLE 16(b)
Composition and Properties of Noise Control Systems of Examples 8 and 10

| | Structural | | | | | |
|---|---|---|---|---|---|---|
| Noise control system | floor | Underlayment | Topping | Membrane | Finish | FIIC |
| Assembly III-Commercial | CLT | NFSIM6 | Concrete | AcoustiTech | Flooring | 56 |
| Membrane + NFSIM6 | | | slab | Premiuim ® | | |
| | CLT | NFSIM6 | Concrete | AcoustiTech | Flooring | 57 |
| | | perforated | slab | Premiuim ® | | |
| Assembly III-Commercial | CLT | NFSIM7 | Concrete | AcoustiTech | Flooring | 55 |
| Membrane + NFSIM7 | | | slab | Premiuim ® | | |
| | CLT | NFSIM7 | Concrete | AcoustiTech | Flooring | 56 |
| | | perforated | slab | Premiuim ® | | |
| Assembly III-Commercial | CLT | NFSIM8 | Concrete | AcoustiTech | Flooring | 54 |
| Membrane + NFSIM8 | | | slab | Premiuim ® | | |
| | CLT | NFSIM8 | Concrete | AcoustiTech | Flooring | 56 |
| | | perforated | slab | Premiuim ® | | |
| Assembly III-Commercial | CLT | NFSIM9 | Concrete | AcoustiTech | Flooring | 53 |
| Membrane + NFSIM9 | | | slab | Premiuim ® | | |
| | CLT | NFSIM9 | Concrete | AcoustiTech | Flooring | 57 |
| | | embossed | slab | Premiuim ® | | |
| Assembly III-Commercial | CLT | NFSIM10 | Concrete | AcoustiTech | Flooring | 54 |
| Membrane + NFSIM10 | | | slab | Premiuim ® | | |
| | CLT | NFSIM10 | Concrete | AcoustiTech | Flooring | 57 |
| | | embossed | slab | Premiuim ® | | |
| Assembly III-Commercial | CLT | NFSIM11 | Concrete | AcoustiTech | Flooring | 52 |
| Membrane + NFSIM11 | | 100% | slab | Premiuim ® | | |
| | CLT | NFSIM11 | Concrete | AcoustiTech | Flooring | 54 |
| | | 75% | slab | Premiuim ® | | |
| | CLT | NFSIM11 | Concrete | AcoustiTech | Flooring | 52 |
| | | 50% | slab | Premiuim ® | | |
| | CLT | NFSIM11 | Concrete | AcoustiTech | Flooring | 50 |
| | | 25% | slab | Premiuim ® | | |
| Assembly III-Commercial | CLT | NFSIM12 | Concrete | AcoustiTech | Flooring | 51 |
| Membrane + NFSIM12 | | 100% | slab | Premiuim ® | | |
| | CLT | NFSIM12 | Concrete | AcoustiTech | Flooring | 54 |
| | | 75% | slab | Premiuim ® | | |
| | CLT | NFSIM12 | Concrete | AcoustiTech | Flooring | 49 |
| | | 50% | slab | Premiuim ® | | |
| | CLT | NFSIM12 | Concrete | AcoustiTech | Flooring | 50 |
| | | 25% | slab | Premiuim ® | | |

### Example 11: FIIC Testing of Noise Control Systems Using Natural Fiber Sound Insulating Mats with Plastic Film Lamination

Different natural fiber sound insulating mats have been laminated by plastic film. Two kinds of commercially available polyethylene film have been applied onto the natural fiber sound insulating mats, the first one is a 140 μm polyethylene film without adhesive system (poly sheeting from Uline) and the second is a 63.5 μm polyethylene self-adhesive film (3M). The films were applied on the surface of the natural fiber sound insulating mat before placing them in the Noise Control System (No. 350, FIG. 4(C)). The resulting FIIC are presented in Table 17.

TABLE 17
Comparison of FIIC Measured on Unlaminated and Laminated
Flat Surface Profiled Natural Fiber Sound Insulating
Mats in the Noise Control System (No. 350, FIG. 4(C))

| | FIIC Measured in Noise | | |
|---|---|---|---|
| | Control System (No. 350, FIG. 4(C)) | | |
| | Without | With Unglued | With Self-adhesive |
| Name | Plastic Film | Plastic 140 μm Film | Plastic 63.5 μm Film |
| Airlaid | 56 | 53 | |
| MDF | | | |
| 1200 g/m² | | | |
| Airlaid | 55 | 54 | 54 |
| NBSK | | | |
| 1200 g/m² | | | |
| Airlaid | 54 | 53 | |
| BCTMP | | | |
| 1200 g/m² | | | |

### Example 12: Effect of Density on FIIC of a Noise Control System

Different sound insulating mats were tested in a noise control system (No. 350, FIG. 4(C)) comprising a flooring, a membrane of AcoustiTech Premium™, a concrete slab topping and a CLT structural floor. According to Table 18 below, and in accordance with the improved insulation properties of the insulating mat and noise control system according to the present invention, the FIIC is higher for the mats having lower density.

TABLE 18
FIIC values as a function of volume density.

| | Density | FIIC of the |
|---|---|---|
| Insulating mat | (kg/m³) | floor assembly |
| NFSIM9 | 52 | 56 |
| NFSIM2 | 71 | 54 |
| High density NFSIM 105 kg/m³ | 105 | 52 |
| High density NFSIM 155 kg/m³ | 155 | 52 |

1: A sound insulating mat for sound insulation comprising at least a layer of combined natural fibers-binder web, the web comprising:
a) natural fibers in the range of 60 to 95 wt. % of the web; and
b) a synthetic binder in the range of 5 to 40 wt. % of the web,
wherein the web comprises a thickness and at least an upper surface and a lower surface opposite each other,
wherein the web has a bulk density of 40 to 150 kg/m³.

2: The mat according to claim 1, wherein at least one of the upper surface and the lower surface has an uneven cross-section profile through the thickness of the web.

3: The mat according to claim 2, wherein the uneven cross-section profile comprises deformations in relation to thickness of the sound insulating mat.

4: The mat according to claim 3, wherein the deformations comprises lumps, indentations, holes, contours, two-dimensional grooves, three-dimensional sinusoidal surfaces, parabolas, spot bondings, or a combination thereof.

5: The mat according to claim 3, wherein the deformations are arranged in a repeating pattern or a random pattern.

6: The mat according to claim 3, wherein the amplitude of the deformations is of at least 15% of the mat thickness.

7: The mat according to claim 1, wherein the sound insulating mat is a footfall mat.

8: The mat according to claim 1, wherein the natural fibers comprises virgin fibers from wood chips, sawdust, plants, agricultural residues, non-virgin recycled fibers from recycled paper, recycled corrugated cardboard, recycled cotton fiber, textile fiber, or a combination thereof.

9. (canceled)

10: The mat according to claim 1, wherein the ratio of the virgin fibers to the recycled fiber is in the range of 0/100 to 100/0.

11: The mat according to claim 1, wherein the natural fibers are mechanical pulp fibers, thermomechanical pulp fibers, chemi-thermomechanical pulp fibers, chemical pulp fibers, ground wood fibers, medium density fiberboard fibers, market pulp fibers, or a combination thereof.

12: The mat according to claim 1, wherein the natural fibers are pre-treated for humidity, fungal growth and/or fire resistance.

13. (canceled)

14: The mat according to claim 13, wherein the synthetic fibers comprise polypropylene, polyethylene, bicomponent fibers, polylactic acid, polylactide or a combination thereof.

15: The mat according to claim 1, wherein the ratio of the natural fibers on the binder is in the ranged of 95/5 to 60/40.

16: The mat according to claim 1, further comprising a post-treatment for vapor, and/or moisture protection.

17: The mat according to claim 1, wherein the mat is flexible and has a dynamic stiffness in the range from 3 to 100 MN/m³.

18. (canceled)

19: The mat according to claim 1, further comprising at least an additional layer, the additional layer being a combined natural fibers-binder web as defined in claim 1, a flat insulating layer, or an even cross-section profile.

20. (canceled)

21. A method for manufacturing an insulating mat as defined in claim 1, comprising at least a layer of combined natural fibers-binder web, the method comprising the steps of:
a) mixing previously opened natural fibers and a synthetic binder to form a natural fibers-binder mixture, the natural fibers representing 60-95 wt. % of the web and the synthetic binder representing 5-40 wt. % of the web;
b) forming the web from the natural fibers-binder mixture, the web having a thickness and at least an upper surface and a lower surface opposite each other; and
c) processing the web so that at least one of the upper surface and the lower surface has an uneven cross-section profile through the thickness of the web, the web having a bulk density of 40 to 150 kg/m³.

22: The method according to claim 21, further comprising at least one of:
prior to the mixing step, pre-treating the natural fibers for humidity, fire and/or fungal growth resistance, and/or mechanically treating the natural fibers;
post-treating the insulating mat to provide water, vapor and/or moisture protection; and
bonding at least an additional lever to the layer of combined natural fibers-binder web, the additional layer being one of a layer of combined natural fibers-binder web as defined in claim 1, a flat insulating layer, or an even cross-section profile.

23-28. (canceled)

29: A noise control system for floor-ceiling comprising:
a) at least one insulating mat according to claim 1;
b) at least two of: a floor finish surface, a topping and a structural floor.

30: The noise control system according to claim 27, comprising the insulating mat stacked between a topping and a structural floor; the insulating mat stacked between a floor finish surface and a structural floor or the insulating mat stacked between a floor finish surface and a topping.

31-34. (canceled)
